(19) United States
(12) Patent Application Publication
(10) Pub. No.: US 2006/0280525 A1
(43) Pub. Date: Dec. 14, 2006

(54) Electrophotographic image forming apparatus and method

(75) Inventors: Kyu-Cheol Shin, Seoul (KR); Myung-Kook Ahn, Suwon-si (KR); Masahiko Itaya, Suwon-si (KR); Tsutomu Teraoka, Seongnam-si (KR); Tsutomu Sasaki, Suwon-si (KR); Naonori Kurogawa, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/356,085

(22) Filed: Feb. 17, 2006

(30) Foreign Application Priority Data
Jun. 11, 2005 (KR) 2005-50145

(51) Int. Cl. G03G 15/01

(52) U.S. Cl. 399/223

(57) ABSTRACT

An electrophotographic image forming apparatus is provided which includes a first developing unit which forms a monochrome image in a two-component development method and includes a photosensitive medium on which an electrostatic latent image is formed by a first exposure unit. Additionally, a plurality of second developing units are provided which form a color image in a one-component development method and include a photosensitive medium on which an electrostatic latent image is formed by a second exposure unit. A control unit generates control signals to independently control the operations of the first and second exposure units and the first and second developing units.

### CROSS-REFERENCE TO RELATED PATENT APPLICATIONS

This application claims the benefit under 35 U.S.C. §119(a) of Korean Patent Application No. 10-2005-0050145, filed on Jun. 11, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an electrophotographic image forming apparatus and method using a duplex type developing portion for forming a monochrome image and a color image in a different manner.

2. Description of the Related Art

The development method of an electrophotographic image forming apparatus such as copiers, printers, facsimiles, and all-in-one printers is divided into a contact development method and a non-contact development method according to whether a developing roller contacts a photosensitive medium on which an electrostatic latent image is formed. In particular, the non-contact development method is divided into one and two-component development methods. The two-component method uses toner and carrier and a one-component development method uses insulation toner or conductive toner according to the component of toner.

Generally, the electrophotographic image forming apparatus uses one of the development methods to form both a color image and a monochrome (black and white) image. Using the same development method, in which the same structure of a developing unit is used, can simplify the structure of the image forming apparatus, decrease the number of parts to be used, and reduce the manufacturing costs. However, although the use of one development method is advantageous because of its simplicity, the cost for printing an image is costly. Moreover, the life span of the developing unit is relatively short. For the two-component development method, while printing costs are low and a relatively long life span is possible, the structure of the developing unit is relatively complicated and the development process is relatively complicated so that the manufacturing costs of the image forming apparatus increase.

Accordingly, there is a need for an electrophotographic image forming apparatus and method which uses using both the one and two-component development methods and which can address color registration problems.

### SUMMARY OF THE INVENTION

An aspect of the present invention is to address at least the above problems and/or disadvantages and to provide at least the advantages described below. Accordingly, an aspect of the present invention is to provide an electrophotographic image forming apparatus and method using both the one and two-component development methods, which is suitable for the need of a user who mainly prints a monochrome image.

Another aspect of the present invention is that it provides an electrophotographic image forming apparatus and method which can address a color registration problem that occurs in the image forming apparatus having the above dual structure.

According to an aspect of the present invention, an electrophotographic image forming apparatus comprises a first developing unit which forms a monochrome image in a two-component development method and includes a photosensitive medium on which an electrostatic latent image is formed by a first exposure unit. A plurality of second developing units are provided which form a color image in a one-component development method and include a photosensitive medium on which an electrostatic latent image is formed by a second exposure unit. A control unit is also provided which generates control signals to independently control the operations of the first and second exposure units and the first and second developing units.

The photographic image forming apparatus may further comprise a first intermediate transfer unit installed to face the first developing unit, and a second intermediate transfer unit installed to face the second developing unit. The control-unit generates control signals to allow the second developing unit and the second intermediate transfer unit to engage with each other to form a color image and to disengage from each other to form a monochrome image.

The photographic image forming apparatus may further comprise a clutch device which allows the second developing unit and the second intermediate transfer unit to engage with or disengage from each other.

The clutch device may comprise a rotating shaft including a rotating body fixed at one end thereof, a clutch portion including a clutch which is installed on the rotating shaft and includes, on an outer circumferential surface of the clutch, a first position determination portion to fix the initial position of the rotating body. A second position determination portion is provided to stop the rotating body at a predetermined position and a rotation control unit controls the rotation of the rotating body by interfering with the first and second position determination portion. A power transfer portion installed on the clutch portion receives a rotational force from a driving source to rotate the rotating shaft.

The clutch may be a spring clutch which is installed on an outer circumferential surface of the rotating shaft.

The rotation control unit may comprise a bracket on which a solenoid portion that is operated by an electric signal is installed. An interference portion is provided which includes one side installed on the bracket and controlling the rotation of the clutch by engaging with or disengaging from the first and second position determination portions when the solenoid portion is turned on or off. The first and second armatures include hook portions to interfere with the first and second position determination portions. The first and second armatures are formed on an end portion of the interference portion. An elastic member has one side installed at the bracket and the other side installed at the interference portion to provide an elastic force to the interference portion to allow the first and second armatures to engage with and disengage from the first and second position determination portions.

The first and second armatures may be arranged to face each other with respect to the clutch and interferes with the first and second position determination portions.

The first position determination portion may engage with the first armature when the solenoid portion is turned on. The second position determination portion is formed at a plurality of positions on an outer circumferential surface of the clutch to separate from the first position determination portion and engages with the second armature when the solenoid portion is turned off.

The clutch device may engage with and disengage from one side of the second intermediate transfer unit.

The clutch device may engage with and disengage from-one side of the second developing unit.

The diameter of the photosensitive medium may be provided in the first developing unit and can be an integral multiple of the diameter of each of the photosensitive medium provided in the second developing unit

The diameter of the photosensitive medium may be provided in the first developing unit and can be greater than the diameter of each of the photosensitive medium provided in the second developing unit

The distance between the first and second developing units can be an integral multiple of the distance between the second developing units.

The control unit generates a control signal that may control the operations of the first and second exposure units and the first and second developing units to form an image on a print medium using only the first developing unit when a monochrome image is formed.

According to another aspect of the present invention, a method for forming an image in an electrophotographic image forming apparatus including a first developing unit forming a monochrome image in a two-component development method, a first intermediate transfer unit installed to face the first developing unit, a plurality of second developing units forming a color image in a one-component development method, and a second intermediate transfer unit installed to face the second developing unit, is achieved by the steps of receiving a print mode from a host, forming an image using only the first developing unit when a monochrome mode is inputted, and, forming an image using the first and second developing units when a color mode is inputted.

The method may further comprise the step of forming an image by allowing the second developing unit and-the second intermediate transfer unit to engage with each other when the color mode is inputted, and forming an image by allowing the second developing unit and the second intermediate transfer unit to disengage from each other when the monochrome mode is inputted.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, and features, and advantages of certain exemplary embodiments of the present invention will be more apparent from the following description taken in conjunction with the accompanying drawings, in which:

FIG. 1 is a cross-sectional view of an image forming apparatus according to an embodiment of the present invention;

FIG. 2 is a cross-sectional view of the first developing unit and the first exposure unit shown in FIG. 1;

FIG. 3 is an enlarged view of a part of FIG. 2;

FIG. 4 is a view illustrating the magnetic brush;

FIG. 5 is a cross-sectional view of the second developing unit and the second exposure unit shown in FIG. 1.

FIG. 6 is an enlarged view of a part of FIG. 5;

FIG. 7 is a perspective view of a clutch device according to an embodiment of the present invention;

FIG. 8 is a bottom view of the clutch device of FIG. 7;

FIG. 9 is a view illustrating the operation of the clutch device of FIG. 7;

FIG. 10 is a view illustrating the operation of the clutch device and the second intermediate transfer unit; and

FIG. 11 is a view showing the constructions of the first and second intermediate transfer units and the photosensitive media provided in the first and second developing units shown in FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

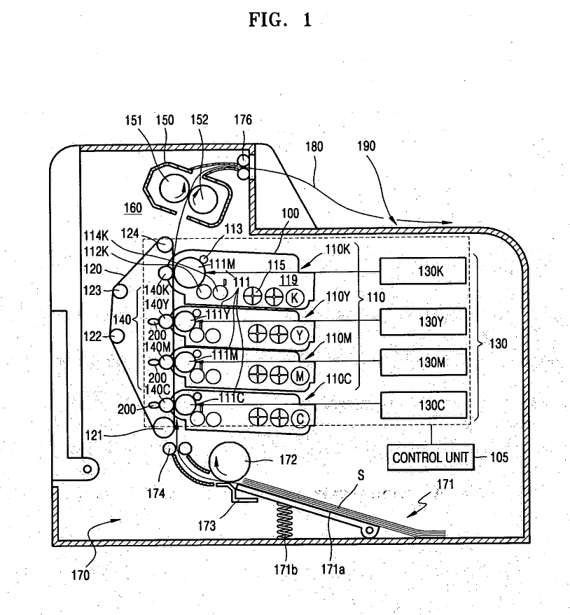

Referring to FIG. 1, an image forming apparatus according to an embodiment of the present invention includes a print unit 160 for printing an image on a print medium S through an electrophotographic process and a paper feed unit 170 for feeding the print medium S. The print unit 160 includes a developing portion 110 for containing toners of different colors, for example, cyan (C), magenta (M), yellow (Y), and black (K) toners, a conveying belt 120, an exposure portion 130, a transfer portion 140, and a fusing portion 150.

The conveying belt 120 is supported by a plurality of support rollers 121, 122, 123, and 124 and circulates around the support rollers 121, 122, 123, and 124. The conveying belt 120 is installed vertically in the present exemplary embodiment. The exposure portion 130 scans light corresponding to image information on cyan, magenta, yellow, and black onto a photosensitive medium 111 of the developing portion 110 according to a computer signal. The photosensitive medium 111 includes photosensitive media 111K, 111C, 111M, and 111Y. The exposure portion 130 includes a first exposure unit 130K for emitting light corresponding to the image information on black and a second exposure unit including a cyan exposure unit 130C, a magenta exposure unit 130M, and a yellow exposure unit 130Y for scanning light corresponding to the image information on cyan, magenta, and yellow. A laser scanning unit (LSU) emits a laser beam and can be employed as the exposure portion 130.

The developing portion 110 forms an image on the print medium S that is moved along the conveying belt 120 and includes a first developing unit 110K for forming a monochrome image and second developing units 110C, 110M, and 110Y for forming a color image. Each of the first and second developing units 110K, 110C, 110M, and 110Y according to this exemplary embodiment includes an opening 117 that forms a path so that the light emitted:by the exposure portion 130 arrives at the photosensitive medium 111 of the developing portion 110. The outer circumferential surfaces of the photosensitive media 111K, 111C, 111M, and 111Y are exposed to the outside face of the conveying belt 120.

The first developing unit 110K forms a monochrome image using a two-component development method while the second developing units 110K, 110M, and 110Y form a color image using a one-component development method. According to the two-component development method, only the charged toner adhering to the outer circumferential surface of a magnet roller adheres to the outer circumferential surface of a developing roller to develop an electrostatic latent image. In the one-component development method, insulation toner or conductive toner is used for development. That is, in the two-component development method, a toner layer is supplied to the developing roller by a carrier brush or a magnetic brush that is formed on the magnet roller. Then, the toner layer adheres to the developing roller and is supplied to the electrostatic latent image on the photosensitive medium 111. In the one-component development method, the toner layer is formed on the developing roller by a restricting member that contacts the developing roller with a predetermined pressure. The toner layer is supplied to the electrostatic latent image on the photosensitive medium 111.

In the one-component development method, since the restricting member contacts the developing roller with a predetermined pressure, the durability of the developing roller deteriorates and the exchange cycle of the developing unit is relatively reduced. In the two component development method, however, a predetermined development gap exists between the developing roller and a magnet roller. A carrier contacts the developing roller and the photosensitive medium 111, or the developing roller and the magnet roller. The developing roller and the magnet roller do not contact each other directly. Thus, the life span of the developing roller or the magnet roller can be extended. Also, since the carrier brush formed on the magnet roller contacts the developing roller only, the deterioration of the carrier is relatively reduced in comparison to the case where the photosensitive medium 111 is directly contacted and a instance where the carrier adheres to the electrostatic latent image together with the toner can be prevented. Thus, the life span of the carrier can be extended. That is, the two-component development method can maintain a longer life span and has a higher durability than the one-component development method. However, since the two-component development method requires additional installation of parts such as the magnet roller, the number of parts increases, and the costs are higher when compared to the one-component development method. That is, when all developing units are embodied in the two-component development method, the overall cost of the image forming apparatus increases accordingly. Thus, by embodying the exemplary embodiments of the present invention to be able to print a monochrome image in the two-component development method which may improve the durability of the developing unit and reduce the cost for printing the image, and a color image in the one-component development-method which may reduce the cost of the image forming apparatus that performs printing only in the two-component development method to meet the need of a user.

The developing unit using the two-component development method has a variety of structures. For example, the developing roller is not installed between the photosensitive medium 111 and the magnet roller and the toner is supplied from the carrier brush formed on the magnet roller to the photosensitive medium 111. This method of supplying toner directly to the photosensitive medium 111 from the magnet roller using the toner and magnetic carrier is referred to as the two-component development method. The above-described method of supplying the toner on the developing roller to the photosensitive medium 111 after the toner is moved from the magnet roller to the developing roller is referred to as a hybrid development method. In the exemplary embodiments of the present invention, the two-component development method refers to a development method including both of the two-component development method and the hybrid development method.

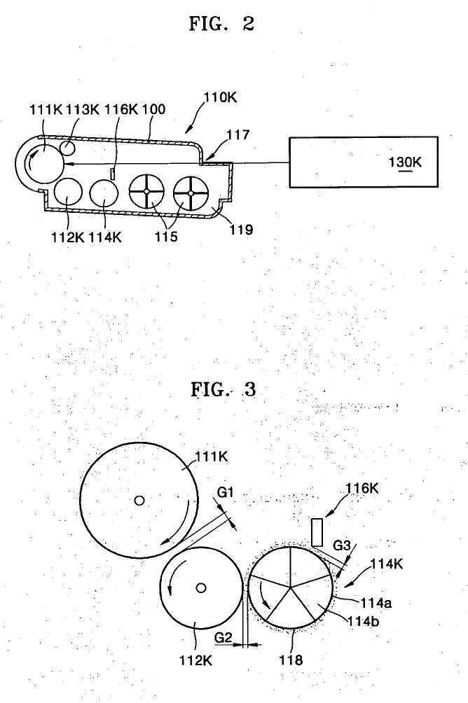

Referring to FIGS. 2 through 4, the first developing unit 110K forms a monochrome image using the two-component development method (a hybrid non-contact development method) and includes the photosensitive medium 111K, a developing roller 112K, a charger 113K, a magnet roller 114K, a restricting member 116K, an agitator 115, and a toner storage portion 119.

The photosensitive medium 111K is installed such that part of the outer circumferential surface is exposed to the outside, and rotates in a predetermined direction. The outer circumferential surface of a metal drum is coated with a photoconductive material layer. In the present exemplary embodiment, an amorphous silicon photosensitive medium or an organic photosensitive medium is employed as the photosensitive medium 111K. The charger 113K and the first exposure unit 130K are provided to form the electrostatic latent image on the photosensitive medium 111K. Also, an electrostatic drum (not shown) can be employed as the photosensitive medium 111K. In this case, an electrostatic recording head (not shown) is employed instead of the first exposure unit 130K.

A charge bias voltage is applied to the charger 113K to charge the outer circumferential surface of the photosensitive medium 111K to a uniform electric voltage. A charge roller or a corona discharger can be employed as the charger 113K.

The developing roller 112K makes the toner adhere to the outer circumferential surface thereof and the toner is supplied to the photosensitive medium 111K. The developing roller 112K contains the toner and supplies the toner to the electrostatic latent image formed on the photosensitive medium 111K to develop a toner image. A development bias voltage for supplying the toner to the photosensitive medium 111K is applied to the developing roller 112K. Also, a development gap G1 is formed between the developing roller 112K and the photosensitive medium 111K. That is, in the present exemplary embodiment, the developing roller 112K is separated a development gap G1 from the outer circumferential surface of the photosensitive medium 111K. The development gap G1 is between 150-400 μm, preferably 200-300 μm. When the development gap G1 is smaller than 150 μm, an image is blurred. When the development gap G1 is larger than 400 μm, the toner is difficult to move toward the photosensitive medium 111K so that a sufficient image concentration cannot be obtained and a selective development phenomenon is generated. An electric field generates a force directing from the photosensitive medium 111K to the developing roller 112K. The charged toner reciprocates and is moved in a development zone formed in the development gap G1, thus performing development. The developing roller 112K has a sleeve shape and is formed of conductive aluminum or stainless steel exhibiting a volume resistivity of not more than 106 Ωcm³. Alternatively, the developing roller 112K has a sleeve shape where conductive resin exhibiting the above volume resistivity is coated around the outer circumferential surface thereof.

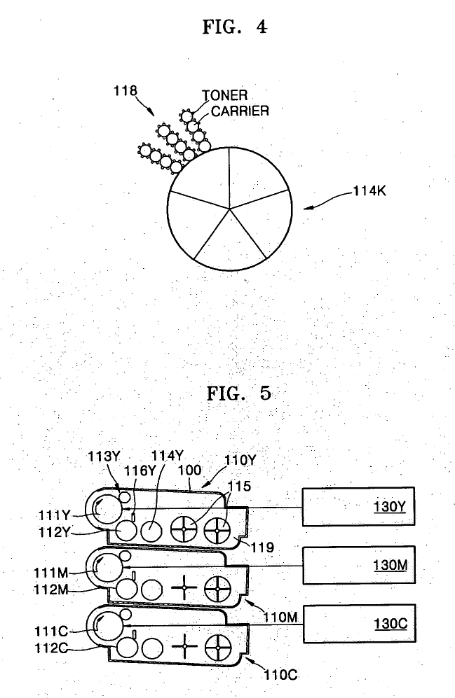

The magnet roller 114K, which makes the toner adhere to the developing roller 112K, and the restricting member 116K, which restricts the quantity of the toner adhering to the magnet roller 114K are installed in a housing 100 around the developing roller 112K. The toner storage portion 119 containing the toner and carrier is provided in the housing 100. The agitator 115 agitates the toner and carrier contained in the toner storage portion 119 to frictionally charge the toner. The magnet roller 114K has a cylindrical sleeve 114a and a magnet 114b. The carrier is attached to the outer circumferential surface of the sleeve 114a by a magnetic force and the toner is attached to the carrier by an electrostatic force. Then, as shown in FIG. 4, a magnetic brush or carrier brush 118 made of the toner and carrier is formed on the outer circumferential surface of the magnet roller 114K. The restricting member 116K restricts the magnetic brush 118 to a predetermined thickness. The gap G3 between the restricting member 146K and the magnet roller 114K is between 0.3-1.5 mm, preferably, 0.3-0.4 mm. Also, a voltage application unit (not shown) applies a bias voltage to each of the photosensitive medium 111K, the developing roller 112K, the charger 113K, and the magnet roller 114K.

In the above structure, the charger 113K charges the surface of the photosensitive medium 111K to have a uniform electric potential. The first exposure unit 130K emits light corresponding to the image information to the photosensitive medium 111K. Thus, an electrostatic latent image including an image portion and a non-image portion, which have different electric potentials, is formed on the surface of the photosensitive medium 111K. The toner is attached to the surface of the carrier by an electrostatic frictional force. The carrier with the toner attached thereto adheres to the magnet roller 114K in the form of the magnetic brush 118. The toner separates from the magnetic brush 118 by the bias voltage applied to the magnet roller 114K and is supplied to the developing roller 112K. To effectively remove the toner remaining on the developing roller 112K and to supply new toner to the developing roller 112K after development, the magnet roller 114K rotates in the opposite direction to the rotation direction of the developing roller 112K. Also, it is more efficient to set the rotation speed of the magnet roller 114K to be 1-2 times faster than that of the developing roller 112K. When the rotation speed of the magnet roller 114K is smaller than that of the developing roller 112K, the toner is insufficiently removed from the developing roller 112K. When the rotation speed of the magnet roller 114K exceeds over two times of that of the developing roller 112K, the stress applied to the toner is increases due to vibrations or heat. When the toner layer formed on the developing roller 112K faces the image portion of the, electrostatic latent image formed on the photosensitive medium 111K, the toner separates from the toner layer of the developing roller 112K and adheres to the image portion so that the electrostatic latent image is developed to a visible toner image. The toner image is transferred to the print medium S by a transfer bias voltage applied by the transfer portion 140.

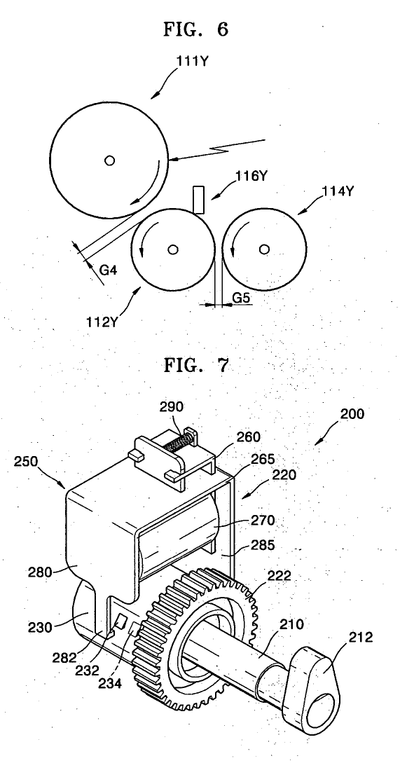

Referring to FIGS. 5 and 6, the second developing units 110C, 110M, and 110Y form a color image using the one-component development method and include the photosensitive media 111C, 111M, and 111Y on which the electrostatic latent images are formed by the second exposure units (130C, 130M, and 130Y). Since the structure and operation of each of the second developing units 110C, 110M, and 110Y are the same and those of each of the second exposure units (130C, 130M, and 130Y) are the same, for clarity and conciseness, the structure and operation of the yellow developing unit 110Y and the yellow exposure unit 130Y will be described in detail below.

The yellow developing unit 110Y includes the photosensitive medium 111Y, a developing roller 112Y, a charger 113Y, a supply roller 114Y, a restriction member 116Y, the agitator 115, and the toner storage portion 119. The photosensitive medium 111Y is rotatably installed having part of the outer circumferential surface thereof exposed to the outside, and is a metal drum of which the outer circumferential surface is coated with an optical conductive substance layer. The charger 113Y and the yellow exposure unit 130Y are provided to form an electrostatic latent image on the surface of the photosensitive medium 111Y. A charge bias voltage is applied to the charger 113Y to charge the outer circumferential surface of the photosensitive medium 111Y to have a uniform electric potential.

The developing roller 112Y supplies the toner adhering to the outer circumferential surface thereof to the photosensitive medium 111Y. The developing roller 112Y accommodates the toner and supplies the toner to the electrostatic latent image formed on the photosensitive medium 111Y, thus forming a toner image. A development bias voltage for supplying the toner toward the photosensitive medium 111Y is applied to the developing roller 112Y. A development gap G4 is formed between the developing roller 112Y and the photosensitive medium 111Y. That is, the developing roller 112Y in the present exemplary embodiment is installed separate from the outer circumferential surface of the photosensitive medium 111Y as wide as the development gap G4. The development gap G4 is within a range of 150-400 μm, preferably, 200-300 μm. A force between the photosensitive medium 111Y and the developing roller 112Y is generated by an electric field. The charged toner performs vibration and reciprocating motions in a development zone formed in the development gap G4 and is moved to carry out development. The developing roller 112Y has a sleeve shape formed of conductive aluminum or stainless steel exhibiting a volume resistivity of not more than 106 Ωcm³ or a sleeve shape having an outer circumferential surface coated with conductive resin exhibiting the above volume resistivity.

The supply roller 114Y for supplying the toner to the developing roller 112Y is provided proximate to the developing roller 112Y. The supply roller 114Y provides the toner so that the toner adheres to the developing roller 112Y. The toner storage portion 119 for containing the toner is provided inside the housing 100. The agitator 115Y agitates the toner at a certain speed to prevent the toner contained in the toner storage portion 119 from being solidified, and transfers the toner toward the supply roller 114Y. The restricting member 116Y for restricting the toner layer has one side fixed to the housing 100 and the other side contacting the developing roller 112Y to restrict the height of the toner adhering to the outer circumferential surface of the developing roller 112Y and frictionally charge the toner to have a polarity. The restricting member 116Y is an elastic metal plate having a thickness of 0.1-0.4 mm and generates a contact pressure (voltage) with respect to the outer circumferential surface of the developing roller 112Y. A gap G5 between the developing roller 112Y and the supply roller 114Y is between 0.2-1.0 mm, preferably 0.3-0.4 mm. A voltage application unit (not shown) applies a bias voltage to each of the photosensitive medium 111Y, the developing roller 112Y, the charger 113Y, and the supply roller 114Y. Each of the developing roller 112Y and the supply roller 114Y, and the developing roller 112Y and the photosensitive medium 111Y, can be installed to contact each other.

In the image forming apparatus configured as above, the charger 113Y charges the surface of the photosensitive medium 111Y to have a uniform electric potential. The yellow exposure unit 130Y emits light corresponding to the image information to form an electrostatic latent image including an image portion and a non-image portion having different electric potentials on the surface of the photosensitive medium 111Y. The toner is supplied to the developing roller 112Y by the supply roller 114Y. When the toner layer formed on the developing roller 112Y faces the image portion of the electrostatic latent image formed on the photosensitive medium 111Y, the toner separates from the toner layer of the developing roller 112Y by an electrostatic force and attaches to the image portion so that the electrostatic latent image is developed to a visible toner image. The toner image is transferred to the print medium S by the transfer bias voltage provided by the transfer portion 140.

The transfer portion 140 is located opposite to the developing portion 110 with respect to the conveying belt 120. A transfer bias voltage has the opposite polarity to the toner image developed on each of the photosensitive media 111C, 111M, 111Y, and 111K so that the toner image is transferred to the print medium S. Here, the toner image is transferred to the print medium S via a electrostatic force acting between the transfer portion 140 and each of the photosensitive media 111C, 111M, 111Y, and 111K. The transfer portion 140 includes a first intermediate transfer unit 140K installed opposite to the first developing unit 110K and second intermediate transfer units 140C, 140M and 140Y respectively installed opposite to the second developing units 110C, 110M, and 110Y. At least one of the second developing units 110C, 110M, and 110Y and the second intermediate transfer units 140C, 140M and 140Y is installed movably. In the present exemplary embodiment, the transfer portion 140 is a transfer roller.

When a monochrome image is printed, since the image is formed only in the two-component development method, high speed printing is possible. The process speed of the first developing unit 110K which uses the two-component development unit is faster than the process speed of the second developing units 110C, 110M, and 110Y which uses the one-component development method. Thus, if the second developing units 110C, 110M, and 110Y are driven during the printing of the monochrome image, the photosensitive media 111C, 111M, and 111Y, developing rollers 112C, 112M, and 112Y, and the conveying belt 120 abrade severely so that the life span of the second developing units 110C, 110M, and 110Y is affected. Thus, for the long life span of the second developing units 110C, 110M, and 110Y, during the printing of a monochrome image, the second developing units 110C, 110M, and 110Y disengage from the second intermediate transfer units 140C, 140M, and 140Y while, during the printing of a color image, the second developing units 110C, 110M, and 110Y engage with the second intermediate transfer units 140C, 140M, and 140Y. To solve the above problems, a clutch device 200 interferes with at least one of the second developing units 110C, 110M, and 110Y and the second intermediate transfer units 140C, 140M, and 140Y to make the second developing units 110C, 110M, and 110Y and the second intermediate transfer units 140C, 140M, and 140Y engage and disengage from each other.

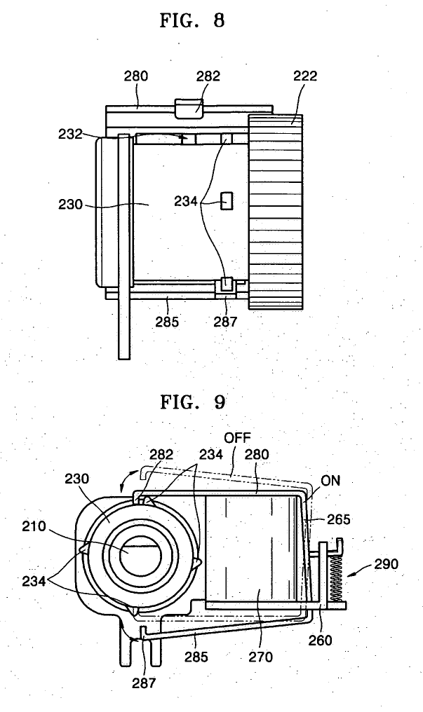

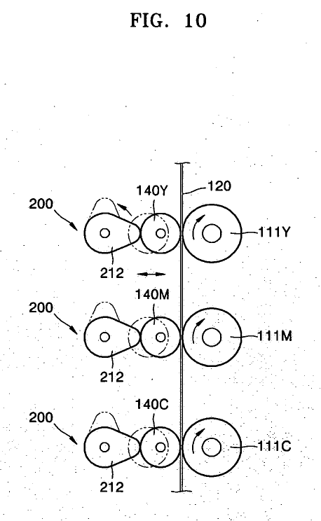

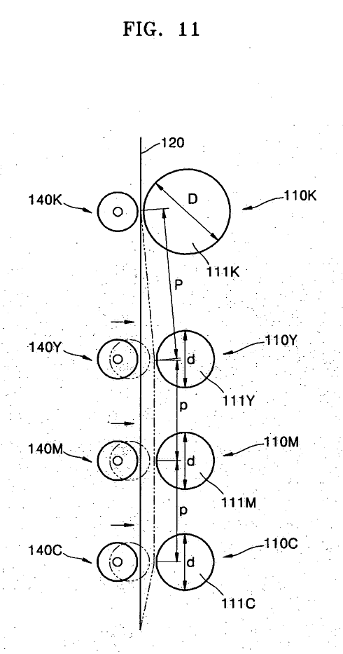

FIG. 7 is a perspective view of a clutch device according to an exemplary embodiment of the present invention. FIG. 8 is a bottom view of the clutch device of FIG. 7. FIG. 9 is a view illustrating the operation of the clutch device of FIG. 7. FIG. 10 is a view for illustrating the operation of the clutch device and the second intermediate transfer unit.

Referring to FIGS. 7 and 8, the clutch device according to the present exemplary embodiment includes a rotating shaft 210 rotating in a direction, a clutch portion 220 installed on the rotating shaft 210, and a power transfer, portion 222 receiving a driving force from a driving source (not shown) and rotating the rotating shaft 210. A rotating body 212 such as a cam is fixed at one end of the rotating shaft 210. The clutch portion 220 is installed at the outer circumferential surface of the rotating shaft 210 and allows the rotational force transferred from the driving source to be transmitted or not transmitted to control the rotation of the rotating shaft 210. The clutch portion 220 includes a clutch 230 installed at the outer circumferential surface of the rotating shaft 210 and a rotation control unit 250 controlling the rotation of the rotating shaft 210.

The clutch 230 includes, at the outer circumferential surface thereof, a first position determination portion 232 for fixing the initial position of the rotating body 212 and a second position determination portion 234 for stopping the rotating body 212 at a predetermined position. The first and second position determination portions 232 and 234 protrude from the outer circumferential surface of the rotating body 212. The first position determination portion 232 engages or disengages with a first armature 280, which will be described later, while the second position determination portion 234 engages or disengages with a second armature 285 (which is also described later). The second position determination portion 234 is formed at a plurality of positions on the outer circumferential surface of the clutch 230 to separate from the first position determination portion 232. To fix the rotating body 212 at a desired position, the second position determination portion 234 is formed at a position corresponding to the desired position. The clutch 230 is a spring clutch. Since the structure and operation of the spring clutch are widely known in the technical field to which the exemplary embodiments of the present invention pertain to, a detailed description thereof will be omitted for clarity and conciseness.

The rotation control unit 250 controls the rotation of the rotating shaft 210 by interfering with the first position determination portions 232 and 234 and includes a bracket 260, an interference portion 265, and an elastic member 290. The bracket 260 includes a solenoid portion 270 that performs on/off operations by an electric signal. When the solenoid portion 270 is electrically connected by the electric signal, a magnetic force is generated so as to pull the interference portion 265 to a predetermined position.

One side of the interference portion 265 is installed at the bracket 260 and interferes with or is relieved from the first and second position determination portions 232 and 234 when the solenoid portion 270 is turned on/off to allow the rotation of the clutch 230 to be transmitted or not transmitted. That is, the interference portion 265 interferes with the first and second position determination portions 232 and 234 formed on the clutch 230 to control the rotation of the clutch 230. First and second armatures 280 and 285, respectively, having hook portions 282 and 287 for respectively interfering with the first and second position determination portions 232 and 234 are provided at the end portion of the interference portion 265. The first and second armatures 280 and 285 are integrally formed with the interference portion 265. The first and second armatures 280 and 285 are arranged to face each other with respect to the clutch 230 and respectively interfere with the first and second position determination portions 232 and 234. The hook portions 282 and 287 of the first and second armatures 280 and 285 are misaligned from each other.

One side of the elastic member 290 is installed at the bracket 260 and the other end thereof is installed at the interference portion 265. The elastic member 290 provides an elastic force to the interference portion 265 so that the first and second armatures 280 and 285 can engage or disengage with the first and second position determination portions 232 and 234.

That is, the solenoid 270 is turned on or off to reciprocate the first and second armatures 280 and 285. As the first and second armatures 280 and 285 interfere with the first and second position determination portions 232 and 234, the rotation of the rotating body 212 installed on the rotating shaft 210 is stopped at a predetermined position. When the solenoid portion 270 is turned on, the interference portion 265 is moved to the predetermined position. At this time, the first armature 280 formed at one side of the interference portion 265 interferes with the first position determination portion 232 to fix the initial position of the rotating body 212. When the solenoid portion 270 is turned off, the interference portion 265 is returned to the original position by the elastic force of the elastic member 290. At this time, the interference by the first armature,280 is removed and the second armature 285 interferes with the second position determination portion 234 so that the rotating body 212 is stopped at a predetermined position. That is, while reciprocating between the predetermined positions by the on/off operation of the solenoid portion 270 and the elastic force of the elastic member 290, the interference portion 265 interferes with or removes the interference from the first and second position determination portions 232 and 234.

As described above, the first position determination portion 232 is engaged with the first armature 280 when the solenoid portion 270 is turned on. The second position determination portion 234 is formed at a plurality of positions along the outer circumferential surface of the clutch 230 to separate from the first position determination portion 232 and to engage with the second armature 285 when the solenoid portion 270 is turned off.

The power transfer portion 222 is installed on the clutch portion 220 and receives the rotational force from the driving source to rotate the rotating shaft 210. The power transfer portion 222 is a gear in the present exemplary embodiment. The driving source generates a driving force to rotate the power transfer portion 222. A driving motor rotating in a predetermined direction can be used as the driving source. The rotational force transmitted by the power transfer portion 222 is selectively transferred by the clutch portion 220 to the rotating shaft 210.

The operation of the clutch device 200 includes setting the initial position of the rotating body 212, stopping the rotating body 212 at a predetermined position, and moving the rotating body 212 to the next position. Referring to FIGS. 7 through 9, in the operation of setting the initial position of the rotating body 212 and stopping the rotating body 212 at the present position, the power transfer portion 222 receives the rotational force from,the driving force and transfers the received rotational force to the clutch 230. Thus, the clutch 230 rotates in a predetermined direction. When the solenoid portion 270 is turned on and pulls the first armature 280, the hook portion 282 formed at the end portion of the first armature 280 interferes with the first position determination portion 232. Accordingly, since the rotational force by the power transfer portion 222 is not transferred to the rotating shaft 210, the rotating body 212 installed at the rotating shaft 210 does not rotate and is stopped. The initial position of the rotating body 212 is set through the above process.

When the solenoid portion 270 is turned off, the interference portion 265 returns to the original position by the elastic member 290. Also, the interference between the first armature 280 and the first position determination portion 232 are removed. Accordingly, the clutch 230 rotates until the hook portion 284 formed at the end portion of the second armature 285 interferes with the second position determination portion 234 formed next to the first position determination portion 232. Thus, since the rotational force of the power transfer portion 222 is not transferred to the rotating shaft 210, the rotating body 212 installed at the rotating shaft 210 does not rotate and is stopped. That is, the interference portion 265 fixes the position of the rotating body 212 when the solenoid portion 270 is turned off.

In the operation of moving the rotating body 212 to the next position, when the second armature 285 interferes with the second position determination portion 234, the rotating body 212 is stopped at a predetermined position. When the solenoid portion 270 is continuously turned on and off, the interference between the second armature 285 and the second position determination portion 234 is removed. Thus, the clutch 230 rotates. Since the solenoid portion 270 is in the off state, the second armature 285 interferes with another second position determination portion 234 located next to the second position determination portion 234 that has been previously engaged by the second armature 285. The rotating body 212 is stopped at a desired position through the above process.

According to the above structure, the clutch device 200 can fix the position of the rotating body 212 when the solenoid portion 270 is turned off. Also, as the second position determination portion 234 is formed at a plurality of positions, the rotating body 212 can be fixed at a desired position.

In an embodiment, as shown in FIG. 10, the clutch device 200 fixes the rotating body 212 at a position indicated by a solid line to allow the second developing units 110C, 110M, and 110Y and the second intermediate transfer units 140C, 140M, and 140Y to contact each other for forming a color image, and the rotating body 212 at a position indicated by an imaginary line to allow the second developing units 110C, 110M, and 110Y and the second intermediate transfer units 140C, 140M, and 140Y to separate from each other for forming a monochrome image. In the exemplary embodiment shown in FIG. 10, the clutch device 200 allows the second developing units 110C, 110M, and 110Y and the second intermediate transfer units 140C, 140M, and 140Y to engage or disengage from each other by interfering or not interfering with the sides of the second intermediate transfer, units 140C, 140M, and 140Y. Although not shown in the drawings, the clutch device 200 interferes or does not interfere with the sides of the second intermediate transfer units 140C, 140M, and 140Y so as to allow the second developing units 110C, 110M, and 110Y and the second intermediate transfer units 140C, 140M, and 140Y to engage or disengage from each other.

In the above-described image forming apparatus having the dual structure using the two-component development method and the one-component development method, the two-component development method is capable of high speed image forming. That is, when a monochrome image is formed, high speed printing is possible because the image is formed using only the two-component development method. Thus, the large diameters of the photosensitive medium 111K and the developing roller 112K are advantageous for the high speed printing and the driving speed must be high as well. Meanwhile, since the second developing units 110C, 110M, and 110Y use the photosensitive media 111C, 111M, and 111Y and the developing rollers 112C, 112M, and 112Y having small diameters to reduce the manufacturing costs, the driving speed must be low. Therefore, the maintenance of the registration becomes difficult when a color image is formed due to the difference in the diameter of the photosensitive medium 111K or the driving speed between the first developing unit 110K and the second developing units 110C, 110M, and 110Y. To address the above problems, the systematic design of the first developing unit 110K and the second developing units 110C, 110M, and 110Y is needed.

FIG. 11 is a view showing the constructions of the first and second intermediate transfer units 140K, 140C, 140M, and 140Y and the photosensitive media 111K, 111Y, 111M, and 111C respectively provided in the first and second developing units 11K, 110C, 110M, and 110Y shown in FIG 1. Referring to FIG. 11, to maintain color registration, the diameter D of the photosensitive medium 111K provided in the first developing unit 110K is an integral multiple of the diameter d of each of the photosensitive media 111C, 111M, and 111Y respectively provided in the second developing units 110C, 110M, and 110Y. That is, the equation that D=n×d where “n” is an arbitrary integer which needs to be satisfied. Since the monochrome image is printed at a high speed, the diameter d of the photosensitive medium 111K provided in the first developing unit 110K needs to be greater than the diameter d of the photosensitive media 111C, 111M, and 111Y respectively provided in the second developing units 110C, 110M, and 110Y. Also, to maintain the color registration, the distance (pitch) P between the first developing unit 110K and the second developing unit 110Y is an integral multiple of the distance (pitch) p between the second developing units 110C and 110M, and 110Y. That is, the equation that P=m×p where “m” is an arbitrary integer which needs to be satisfied. For example, when the diameter of each of the photosensitive media 111C, 111M, and 111Y provided in the second developing units 110C, 110M, and 110Y is 20 mm and the distance (pitch) between the second developing units 110C and 110M, and 110Y and the distance (pitch) between the second developing units 110C and 110M, and 110Y is 45 mm, the diameter of the photosensitive medium 111K of the first developing unit 110K is 40 or 60 mm and the distance (pitch) between the first developing unit 110K and the yellow developing unit 110Y is 90 or 135 mm. When the first developing unit 110K and the second developing units 110C, 110M, and 110Y are designed as described above, the registration can be relatively easily maintained when a color image is formed.

Referring back to FIG. 1, a control unit 105 generates control signals for independently controlling the operations of the first and second exposure units 130K, 130C, 130M, and 130Y, the first and second developing units 110K, 110C, 110M, and 110Y, the first and second intermediate units 140K, 140C, 140M, and 140Y, and the clutch device 200. For example, the control unit 105 generates control signals to control the operation of the clutch device 200 so that the second developing units 110C, 110M, and 110Y and the second intermediate transfer units 140C, 140M, and 140Y contact each other for forming a color image and the second developing units 110C, 110M, and 110Y and the second intermediate transfer units 140C, 140M, and 140Y are disengaged from each other for forming a monochrome image. When a monochrome image is formed, the control unit 105 needs to control the operations of the first and second exposure units 130K, 130C, 130M, and 130Y and the first and second developing units 110K, 110C, 110M, and 110Y to form an image on the print medium S using only the first developing unit 110K. That is, when a monochrome image is formed, the control unit 105 controls the operation of each constituent element to form the image using only the first developing unit 110K and the first exposure unit 130K. Also, the control unit 105 controls such that a tangential speed on the surface of the photosensitive medium 111K provided in the first developing unit 110K and tangential speeds on the surfaces of the photosensitive media 111C, 111M, and 111Y provided in the second developing units 110C, 110M, and 110Y are nearly identical

The fusing portion 150 includes a heating roller 151 and a pressure roller 152 which fuse the toner image on the print medium S by applying heat and pressure to the toner image transferred to the print medium S. The heating roller 151 is a heat source for permanently fixing the toner image and installed to face the pressure roller 152 in the axial direction. The pressure roller 152 is installed to face the heating roller 151 ad applying a high pressure against the print medium S to fuse the toner image on the print medium S.

A paper discharge roller 176 ejects the print medium S that is completely fused out of the electrophotographic image forming apparatus. The print medium S ejected by the paper discharge roller 176 along a print medium transfer path 180 is stacked on a top tray 190.

The image forming apparatus includes in a lower portion thereof a paper feeding apparatus 170 for feeding the print medium S to the print unit 160. The paper feeding apparatus 170 includes a paper feed cassette 171 containing the print medium S, a pickup roller 172 for picking the print medium S up from the paper feed cassette 171, and a duplex transfer prevention member 173 for preventing the duplex transfer of the print medium S. A multi-purpose feeder (MPF) for additionally loading print media can be provided at one side of the image forming apparatus. The MPF is mainly used to transfer an OHP print medium or an irregular print medium.

The paper feed cassette 171, as an example of a loading device for loading the print medium S, includes a knock-up plate 171a where the print medium S is loaded and an elastic member 171b for elastically biasing the knock-up plate 171a upwardly.

The print medium S loaded on the knock-up plate 171a is transferred one by one by the pickup roller 172 that is described later. Since duplex transfer, that is, a plurality of sheets of print medium S loaded on the knock-up plate 117a can be picked up together, can occur, a frictional member (not shown) is provided at the position opposite to the pickup roller 172 is provided on the upper surface of the knock-up plate 171a. The friction member prevents the duplex transfer by providing a frictional force greater than a frictional force between the sheets of the print medium S to the rear surface of the last print medium S.

The elastic member 171b elastically biases the print medium S loaded on the knock-up plate 171a toward the pickup roller 172. That is, the elastic member 171b makes the print medium S loaded on the knock-up plate 171a contact the pickup roller 172 and the print medium S is transferred by the pickup roller 172 one by one.

The pickup roller 172 is manufactured using EPDM to increase a frictional force with the print medium S. That is, the surface of the pickup roller 172 contacting the print medium S is made of EPDM. In addition to EPDM, NR based, NBR based, urethane based, or silicon based rubber can be employed as a material of the pickup roller 172.

A feed roller 174 transfers the print medium S picked up by the pickup roller 172 from the paper feed cassette 171 toward the print unit 160. The print medium S passes through the print unit 160 during which the toner image is transferred to the print medium S. The toner image transferred to the print medium S is fused on the print medium S by the fusing portion 150 and the print medium S is ejected by the paper discharge roller 176 out of the image forming apparatus.

In the method of forming an image in the image forming apparatus according to the exemplary embodiments of the present invention, the image forming apparatus having a duplex, type developing unit as described above is operated in a monochrome mode and a color mode according to the mode of printing input by a host (not shown) such as a computer. That is, when the monochrome mode is inputted from the host, an image is formed using only the first developing unit 110K, and when a color mode is inputted, an image is formed using both the first and second developing units 110K, 110C, 110M, and 110Y. In other words, the image forming apparatus according to the exemplary embodiments of the present invention forms an image by separating the second intermediate transfer units 140C, 140M, and 140Y from the second developing units 110C, 110M, and 110Y when the monochrome mode is inputted. When the color mode is inputted, an image is formed by allowing the second intermediate transfer units 140C, 140M, and 140Y to contact the second developing units 110C, 110M, and 110Y.

In the image forming process when the color mode is inputted, color image information is a mixture of information corresponding to cyan C, magenta M, yellow Y, and black K. In the present exemplary embodiment, the toner image of each color is transferred to the print medium S in the sequence of cyan C, magenta M, yellow Y, and black K and the transferred toner images are fused to form a color image.

When the paper feed cassette 171 is installed in the image forming apparatus after the print medium S is loaded in the paper feed cassette 171, the following image forming process is performed.

The photosensitive media 111C, 111M, 111Y, and 111K of the second and first developing units 110C, 110M, 110Y, and 110K are charged to a uniform electric potential by the charge bias voltage applied by the charger 113C, 113M, 113Y, and 113K. The four exposure units 130C, 130M, 130Y, and 130K emit light corresponding to image information about cyan, magenta, yellow, and black through the opening 117 of each of the developing units 110C, 110M, 110Y, and 110K to the photosensitive media 111C, 111M, 111Y, and 111K of the developing units 110C, 110M, 110Y, and 110K. When the light is emitted, only the area on which the light is scanned is selectively discharged so that the electric potential of the area is lowered. An output pattern formed by this difference in electric potential is the electrostatic latent image.

The toner is supplied by the supply rollers 114C, 114M, and 114Y or the magnet roller 14K to the developing rollers 112C, 112M, 112Y, and 112K to which the development bias voltage is applied. The toner adhering to the outer circumferential surface of each of the developing rollers 112C, 112M, 112Y, and 112K is transferred to the electrostatic latent image formed on the outer circumferential surface of each of the photosensitive media 111C, 111M, 111Y and 111K, and adheres to the electrostatic latent image. The toner images of cyan, magenta, yellow, and black are formed on the photosensitive media 111C, 111M, 111Y, and 111K of the developing units 110C, 110M, 110Y, and 110K.

While pressing the upper surface of the print medium S loaded on the knock-up place 171a, the pickup roller 172 rotates to transfer the print medium S output of the paper feed cassette 171. The print medium S is moved to the conveying belt 120 by the feed roller 174. The print medium S is attached to the surface of the conveying belt 120 by an electrostatic force and moved at the same speed as a linear speed of the conveying belt 120. For example, the leading end of the print medium S arrives at a transfer nip (not shown) located opposite to the transfer portion 140 in timed relation with the arrival of the leading end of the toner image of the cyan C toner image formed on the outer circumferential surface of the photosensitive medium 111C of the developing unit 110C.

When the transfer bias voltage is applied to the transfer portion 140, the toner image formed on the photosensitive medium 111C is transferred to the print medium S. As the toner medium S is transferred, the toner images of magenta M, yellow Y, and black K formed on the photosensitive media 111M, 111Y, and 111K of the developing units 110M, 110Y, and 110K are sequentially transferred to the print medium S to overlap with one another so that a color toner image is formed on the print medium S.

The fusing portion 150 applies heat and pressure to the color toner image formed on the print medium S to allow the color toner image on the print medium S. The print medium S is ejected out of the image forming apparatus by the paper discharge roller 176. The print medium S transferred along the print medium transfer path 180 by the paper discharge roller 176 is loaded on the top tray 190.

The image forming process in the monochrome mode is similar to the image forming process in the color mode. In the monochrome mode, however, the second developing units 110C, 110M, and 110Y and the second intermediate transfer units 140C, 140M, and 140Y disengage and the second exposure units 130C, 130M, and 130Y are not operated. That is, when a monochrome image is formed, the image is formed using the first developing unit 110K and the first exposure unit 130K.

As described above, in the electrophotographic image forming apparatus and method according to the exemplary embodiments of the present invention, since the duplex type developing unit is used unlike the conventional devices, an image can be formed more efficiently. Also, for a monochrome image that users request most, the two-component development method is employed to improve durability of the developing unit although high speed printing is still available. For a color image, by employing the one-component developing method, the image forming apparatus can be realized at a lower cost than the image forming apparatus employing the two-component development method so that an image forming apparatus meeting the needs by the users can be provided. The exemplary embodiments of the present invention can realize a fast printing speed in the monochrome mode by using the duplex type developing unit.

The color registration problem which may easily occur in the duplex type image forming apparatus can be solved by the structural design and the life span of the developing units can be extended by independently printing according to the monochrome mode and color mode. The durability of the constituent elements can be improved by disengaging the second developing units and the second intermediate transfer units using the clutch device when a monochrome image is formed. Further, the solenoid portion can be prevented from being overheated because the clutch device is provided to fix the position of the rotating body when the solenoid portion is turned off. Also, since the second position determination portion is installed at a plurality of positions, the rotating body can be fixed at a desired position so that the operation of the rotating body can be easily controlled. Also, since the armatures for changing the position of the rotating body, setting the initial position of the rotating body, and fixing the position of the rotating body are arranged to face each other with respect to the clutch and can be misaligned from each other, the position of the rotating body can be relatively smoothly changed.

While the exemplary embodiments of the invention have been particularly shown and described with reference to exemplary embodiments thereof, it will be understood by those skilled in the art that various changes in form and details may be made therein without departing from the spirit and scope of the exemplary embodiments of the invention as defined by the appended claims.

What is claimed is:

1. An electrophotographic image forming apparatus comprising:
a first developing unit which forms a monochrome image in a two-component development method, the first developing unit includes a photosensitive medium on which an electrostatic latent image is formed by a first exposure unit;
a plurality of second developing units which form a color image in a one-component development method, the plurality of second developing units include a photosensitive medium on which an electrostatic latent image is formed by a second exposure unit; and
a control unit which generates control signals to independently control the operations of the first and second exposure units and the first and second developing units.

2. The apparatus as claimed in claim 1, further comprising:
a first intermediate transfer unit installed to face the first developing unit; and
a second intermediate transfer unit installed to face the second developing unit,
wherein the control unit generates control signals to allow the second developing unit and the second intermediate transfer unit to engage with each other to form a color image and to disengage from each other to form a monochrome image.

3. The apparatus as claimed in claim 2, further comprising a clutch device which allows the second developing unit and the second intermediate transfer unit to engage with or disengage from each other.

4. The apparatus as claimed in claim 2, wherein the clutch device comprises:
a rotating shaft including a rotating body fixed at one end thereof;
a clutch portion including a clutch which is installed on the rotating shaft, the clutch portion includes, on an outer circumferential surface of the clutch, a first position determination portion to fix the initial position of the rotating body and a second position determination portion to stop the rotating body at a predetermined position, and a rotation control unit which controls the rotation of the rotating body by interfering with the first and second position determination portion; and
a power transfer portion installed on the clutch portion to receive a rotational force from a driving source to rotate the rotating shaft.

5. The apparatus as claimed in claim 4, wherein the clutch is a spring clutch which is installed on an outer circumferential surface of the rotating shaft.

6. The apparatus as claimed in claim 4, wherein the rotation control unit comprises:
a bracket on which a solenoid portion that is operated by an electric signal is installed;
an interference portion including one side installed on the bracket to control the rotation of the clutch by engaging with or disengaging from the first and second position determination portions when the solenoid portion is turned on or off, wherein first and second armatures including hook portions interfere with the first and second position determination portions are formed on an end portion of the interference portion; and
an elastic member including one side installed at the bracket and the other side installed at the interference portion, the elastic member provides an elastic force to the interference portion to allow the first and second armatures to engage with and disengage from the first and second position determination portions.

7. The apparatus as claimed in claim 6, wherein the first and second armatures are arranged to face each other with respect to the clutch and interfere with the first and second position determination portions.

8. The apparatus as claimed in claim 6, wherein the first position determination portion engages with the first armature when the solenoid portion is turned on, and the second position determination portion is formed at a plurality of positions on an outer circumferential surface of the clutch to separate from the first position determination portion and engages with the second armature when the solenoid portion is turned off.

9. The apparatus as claimed in claim 3, wherein the clutch device engages with and disengages from one side of the second intermediate transfer unit.

10. The apparatus as claimed in claim 3, wherein the clutch device engages with and disengages from one side of the second developing unit.

11. The apparatus as claimed in claim 1, wherein the diameter of the photosensitive medium provided in the first developing unit is an integral multiple of the diameter of each of the photosensitive medium provided in the second developing unit

12. The apparatus as claimed in claim 11, wherein the diameter of the photosensitive medium provided in the first developing unit is greater than the diameter of each of the photosensitive medium provided in the second developing unit

13. The apparatus as claimed in claim 1, wherein the distance between the first and second developing units is an integral multiple of the distance between the second developing units.

14. The apparatus as claimed in claim 1, wherein the control unit generates a control signal that control the operations of the first and second exposure units and the first and second developing units to form an image on a print medium using only the first developing unit when a monochrome image is formed.

15. A method for forming an image in an electrophotographic image forming apparatus including a first developing unit forming a monochrome image in a two-component development method, a first intermediate transfer unit installed to face the first developing unit, a plurality of second developing units forming a color image in a one-component development method, and a second intermediate transfer unit installed to face the second developing unit, the method comprising the steps of:
receiving a print mode from a host;
forming an image using only the first developing unit when a monochrome mode is inputted; and
forming an image using the first and second developing units when a color mode is inputted.

16. The method as claimed in claim 15, further comprising forming an image by allowing the second developing unit and the second intermediate transfer unit to engage with each other when the color mode is inputted, and forming an image by allowing the second developing unit and the second intermediate transfer unit to disengage from each other when the monochrome mode is inputted.
